(19) United States
(12) Patent Application Publication
(10) Pub. No.: US 2019/0065694 A1
(43) Pub. Date: Feb. 28, 2019

(54) DIETING TOOL AND METHOD BASED ON CONTROLLED CARBOHYDRATE INTAKE

(71) Applicant: Debbie Latham, Sulphur Springs, TX (US)

(72) Inventor: Debbie Latham, Sulphur Springs, TX (US)

(21) Appl. No.: 15/687,497

(22) Filed: Aug. 27, 2017

(51) Int. Cl. G06F 19/00

(52) U.S. Cl. CPC G06F 19/3475

(57) ABSTRACT

A dieting tool for educating controlled carbohydrate intake to a user, comprises a carbohydrate guide. The carbohydrate guide comprises a list of consumable food items and a corresponding value of exchange article. The value of the exchange article is based on the amount of carbohydrate in the consumable food items. The exchange article is most familiar article such as currency, for buying the consumable food items. The present invention also discloses a method for educating controlled carbohydrate intake to a user. Said tool and method helps in educating the user to count carbohydrate intake efficiently while purchasing/consuming the food items.

### BACKGROUND OF THE INVENTION

The invention disclosed herein generally relates to dieting tools and methods. More particularly, the invention disclosed herein relates methods for dieting and health management, which provide knowledge on their carbohydrate intake using an exchange tool for a user.

### DESCRIPTION OF THE PRIOR ART

People have become aware of the importance of a proper diet for health management, disease prevention and treatment. There are numerous different, and conflicting dietary guidelines are presented in complex manners, which is very difficult for a user to follow a diet for health and disease management. Further, the problem of planning and maintaining a healthful diet goes beyond the usual health concerns and exists with respect to special diet situations, including those associated with diet-responsive conditions, such as cardiovascular disease, diabetes and cancer.

There are many educators, medical personnel and facilities providing care and supervision to diabetics and individuals in need to control carbohydrate intake in the diet for various reasons. The personnel and educators working in these facilities regularly attempt to educate people from all socio-economic backgrounds, with various learning levels to count carbohydrate. Currently, diet management assistance provided for the people has been of limited value and often fails to satisfy long term compliance. Further, most of the people usually lack sufficient knowledge in the field of nutrition to implement an adequate diet plan as part of a system or method for health management. In addition, food and choice restrictive diets can be very harmful to the dieter. For example, being on no-carb diet for a long period of time has many down sides. These include: decreased metabolism; depression; increased irritability; loss of concentration; loss of energy; loss of strength; high cholesterol; lack of fiber; vitamin deficiencies; dehydration; gastrointestinal problems; kidney disease; gallbladder disease; and heart disease.

Previous approaches to health management have included various physical devices to assist in counting macro- or micronutrients or otherwise planning and maintaining his or her diet. These have included manipulating devices, as disclosed in U.S. Pat. Nos. 4,606,555 and 4,625,675; various coupon and label systems, as disclosed in U.S. Pat. Nos. 4,310,316, 4,652,241, and 4,689,019; and card menus identifying meal exchanges, as disclosed in U.S. Pat. No. 4,950,164. Nevertheless, these devices, coupons, labels, and the like do not solve the problems addressed above of assisting users or patients by providing a simple, familiar management tool for consuming convenient meals composed of appropriate foods and beverages which satisfy the complex goals of a healthy diet over a period.

Hence, there is a long felt but unresolved need for a method and tool for educating people to count carbohydrate from their consumable food items. Further, there is a need for a familiar and simple exchange tool and method, which could assist users count on their carbohydrate intake.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention relates to a dieting tool for educating/maintaining controlled carbohydrate intake by a user. In an embodiment. The dieting tool comprises a carbohydrate guide or carbohydrate cheat sheet for maintaining the user's diet. In one embodiment, the carbohydrate guide comprises a list of consumable food items and a corresponding value of an exchange article. The value of the consumable food items are in accordance to the amount of carbohydrate in the consumable food items. Henceforth, the user is educated to count carbohydrate intake while purchasing/consuming the food items.

The present invention is also related to a method for educating/maintaining controlled carbohydrate intake by a user. The method comprises the steps of: determining an optimal carbohydrate intake by a user, providing a carbohydrate guide to the user, wherein the carbohydrate guide comprising at least a list of consumable food items and a corresponding value of exchange article in accordance to the amount of carbohydrate in the consumable food items, and purchasing/consuming the food items using the exchange article value in accordance to the determined optimal carbohydrate intake by the user, thereby educating the user to count carbohydrate intake.

In one embodiment, the dieting tool further comprises at least a list of consumable non-carbohydrate food items. In some embodiments, the corresponding exchange article is currency.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a dieting tool comprising a carbohydrate guide or carbohydrate cheat sheet, according to an aspect of the present invention.

FIG. 2 exemplarily illustrates a dieting tool comprising a list of consumable non-carbohydrate food items, according to another aspect of the present invention.

FIG. 3 exemplarily illustrates a method for educating controlled carbohydrate intake by a user, according to another aspect of the present invention.

FIG. 4 illustrates an exemplary computing environment within which embodiments of the present disclosure can be implemented.

### DESCRIPTION OF THE PREFERRED EMBODIMENT

The present invention pertains to a dieting tool for educating controlled carbohydrate intake to a user. The dieting tool generally comprises a carbohydrate guide or cheat sheet, where it is used for assisting the user in learning to count the carbohydrate content in consumable food items. The carbohydrate guide comprises a list of consumable food items and a corresponding value of exchange article. The value of the exchange article is based on the amount of carbohydrate in the consumable food items. The exchange article is most familiar article such as currency, for buying the consumable food items. The present invention also discloses a method for educating controlled carbohydrate intake to a user. Said tool and method helps in educating the user to count carbohydrate intake efficiently while purchasing/consuming the food items.

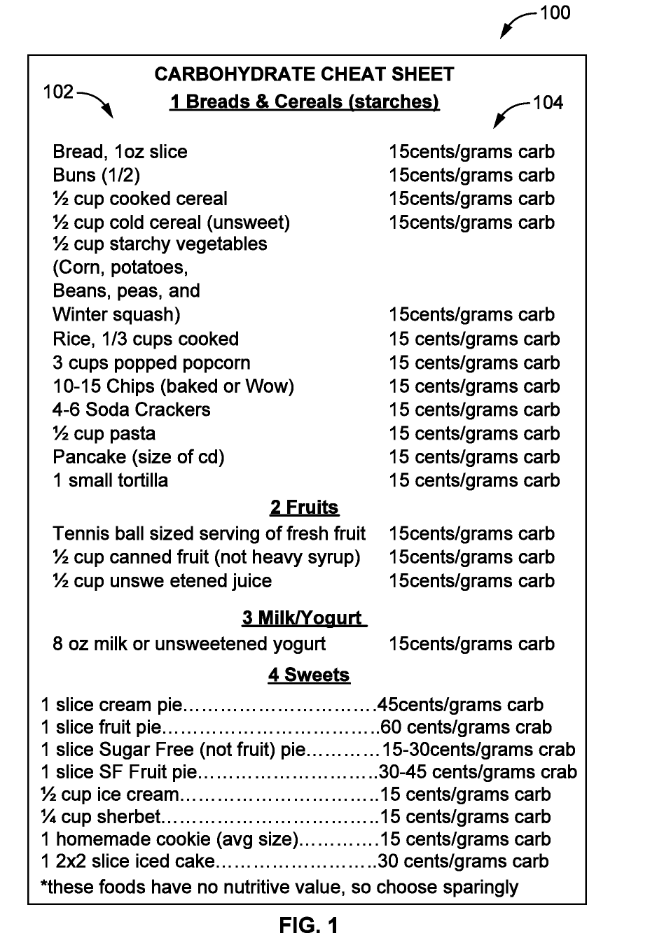

FIG. 1 exemplarily illustrates a dieting tool 100 comprising a carbohydrate guide or carbohydrate cheat sheet, according to an embodiment of the present invention. In some embodiments, the guide could be in any form, such as digital display, sheet, etc. based on the user's convenience. In an embodiment, the carbohydrate guide comprises a list of consumable food items 102 and a corresponding value of exchange article 104. The value of the exchange article 104 is based on the amount of carbohydrate in the consumable food items 102.

The exchange article could be a familiar exchange article such as currency, for buying the consumable food items 102. The currency could be United States currency, and equivalent in pesos, fen, and other countries currency. Here, the currency is used as a visual exchange for carbohydrates content (in grams) of the consumable food items. For an example, if an orange contains 15 grams of carbohydrate, the value of one orange is 15 cents, where the number of oranges will be valued to a multiple of 15 cents.

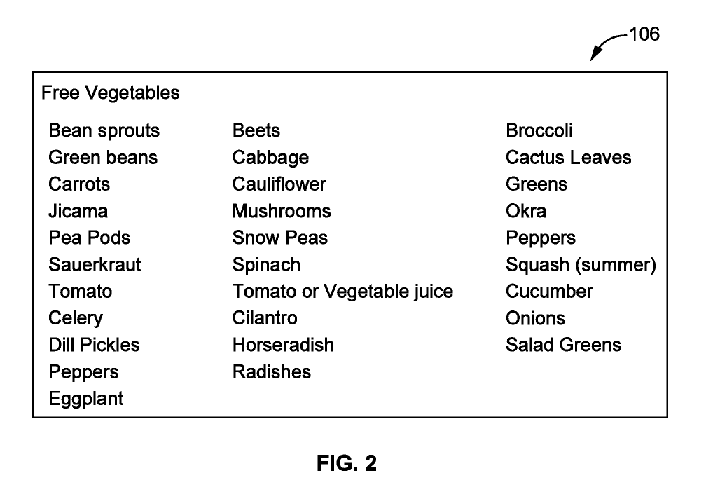

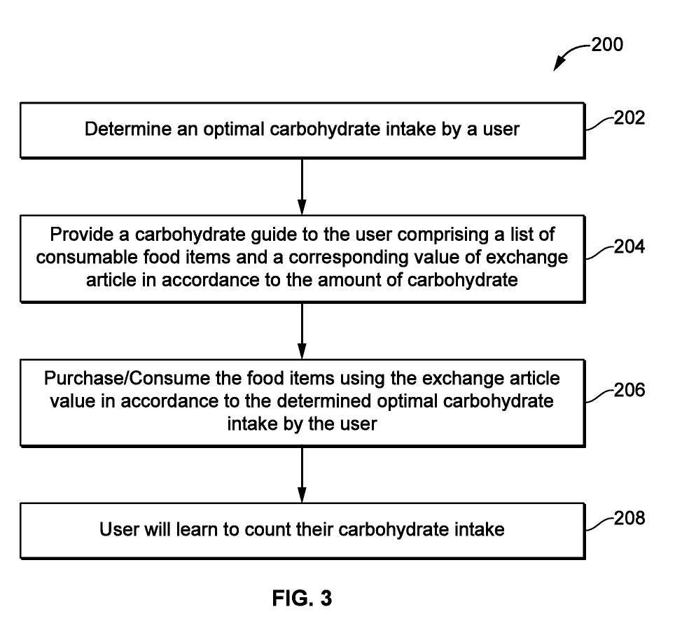

FIG. 2 exemplarily illustrates a dieting tool comprising a list of consumable non-carbohydrate food items 106. In one embodiment, the dieting tool further comprises at least a list of consumable non-carbohydrate food items 106. The user could buy, or consume non-carbohydrate food items in free of cost. FIG. 3 exemplarily illustrates a method 200 for educating controlled carbohydrate intake by a user. The method 200 comprises the steps of, determining an optimal carbohydrate intake by a user in step 202. In step 204, a carbohydrate guide is provided to the user. The carbohydrate guide comprises at least a list of consumable food items and a corresponding value of exchange article in accordance to the amount of carbohydrate in the consumable food items. In step 206, the food items are purchased or consumed using the exchange article value in accordance to the determined optimal carbohydrate intake by the user, thereby educating the user to count carbohydrate intake in step 208.

In an embodiment, the user could be instructed to have currencies or coins in equivalent to the amount of carbohydrates content (in grams), where the user could plan their each meal. This method 200 allows the user to use a familiar means of exchange to the associated carbohydrate content in the consumable food items. Further, the user could be provided with the carbohydrate guide or cheat sheet listing the common food items and corresponding grams of carbohydrate content as cents, shown in FIG. 1.

In an example, a hypothetical trip of a user to the grocery store is used to demonstrate carbohydrate counting. To purchase a food item, the user have to check for the carbohydrate content (in grams) of the food items, where the user have to pay in accordance to the amount of carbohydrate content, or multiple carbohydrate content in the food items. Further, the user is given with a carbohydrate cheat sheet as their pricing guide, where they could select their food items according to their budget or their diet plan. In another example, a hypothetical trip of a user to a restaurant is used to demonstrate carbohydrate counting. To order a hamburger, the user have to have to check for the carbohydrate content (for an instance, 30 grams) of the hamburger, where the user have to pay 30 cents in accordance to the amount of carbohydrate content, or multiple carbohydrate content (multiples of 30 cents) in the hamburger. Further, the user could order based on their personal carbohydrate allowance per meal, and save their money.

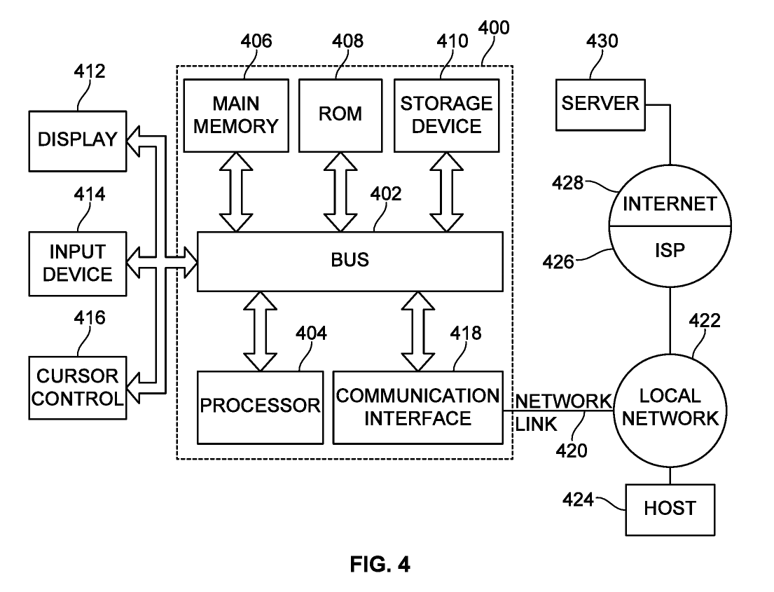

FIG. 4 illustrates an exemplary computing environment within which the embodiments of the present disclosure can be implemented. Computer system 400 includes a bus 402 or other communication mechanism for communicating information, and a hardware processor 404 coupled with bus 402 for processing information. In some embodiments, hardware processor 404 can be, for example, a general-purpose microprocessor or it can be a reduced instruction set microprocessor.

Computer system 400 also includes a main memory 406, such as a random access memory (RAM) or other dynamic storage device, coupled to bus 402 for storing information and instructions to be executed by processor 404. Main memory 406 also can be used for storing temporary variables or other intermediate information during execution of instructions by processor 404. Such instructions, when stored in non-transitory storage media accessible to processor 404, render computer system 400 into a special-purpose machine that is customized to perform the operations specified in the instructions.

In some embodiments, computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 can be coupled via bus 402 to a display 412, such as a cathode ray tube (CRT) or LCD panel, for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. The input device typically has degrees of freedom in two axes, a first axis (for example, x) and a second axis (for example, y), that allows the device to specify positions in a plane.

Computer system 400 can implement the processes and techniques described herein using customized hard-wired logic, one or more ASICs or FPGAs, firmware and/or program logic which in combination with the computer system causes or programs computer system 400 to be a special-purpose machine. In some embodiments, the processes and techniques herein are performed by computer system 400 in response to processor 404 executing one or more sequences of one or more instructions contained in main memory 406. Such instructions can be read into main memory 406 from another storage medium, such as storage device 410. Execution of the sequences of instructions contained in main memory 406 causes processor 404 to perform the process steps described herein. In other embodiments, hard-wired circuitry can be used in place of or in combination with software instructions.

The term “storage media” as used herein refers to any non-transitory media that store data and/or instructions that cause a machine to operate in a specific manner. Such storage media can comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but can be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media can be involved in carrying one or more sequences of one or more instructions to processor 404 for execution. For example, the instructions can initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 can optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 can be an integrated service digital network (ISDN) card, cable modem, satellite modem, or a modem to provide a data communication connection to a corresponding type of telephone line. As another example, communication interface 418 can be a local area network (LAN) card to provide a data communication connection to a compatible LAN. Wireless links can also be implemented. In any such implementation, communication interface 418 sends and receives electrical, electromagnetic or optical signals that carry digital data streams representing various types of information.

Network link 420 typically provides data communication through one or more networks to other data devices. For example, network link 420 can provide a connection through local network 422 to a host computer 424 or to data equipment operated by an Internet Service Provider (ISP) 426. ISP 426 in turn provides data communication services through the world-wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code can be executed by processor 404 as it is received, and/or stored in storage device 410, or other non-volatile storage for later execution.

The present invention further relates to a computer system 400 and method for teaching or educating about improving diet comprehension and compliance in the treatment of chronic disease, such as diabetes, heart disease, etc. Computer system 400 implements carbohydrate dieting tool teaching via interaction with learners to increase/improve learner comprehension and retention. Herein, currency is used as a means of exchange based upon carbohydrate grams, where the currency is familiar to most of the ethnicities, literacy levels and cultures. The education process via computer system teaches and updates information on adopting currency, which allows the user to learn new familiar, or unfamiliar information about carbohydrate intake.

The carbohydrate system 400 and method is incorporated with one or more modules, stored in the main memory 406 which coupled via bus 402 or any other communication interface to one or more processors 404. The modules include, Personality driven learning module, Personalized/Individualize carbohydrate recommendation module, Carbohydrate cheat sheet module, Interactive reinforcement of learning module, Measured comprehension of learning module, and learning and knowledge transfer module.

The personality driven learning module adapts, and set to provide education to the user preferred learning method. For example, the teaching process/seminar adapts at least portions of the educational content to a personality-driven learning style of the learner. The learner is given a voluntary list of questionnaires, and interactive education lessons to determine learners preferences in learning. The seminar may include different learning styles such as, visual learning, auditory learning or kinesthetic learning, which may be selected based on the user's preference.

The personalized/individualize carbohydrate recommendation module receive input from the users via one or more input devices, and utilizes user feedback to provide personalized/individualize education. User inputs into the computer system, such as height, weight, age, and desired weight goal to receive a recommended carbohydrate allowance for the user's diet. Further, the personalized/individualize carbohydrate recommendation module provides an information on approximate carbohydrate level of their current diet intake through interactive exercises to the user. This information is used to assist the users in making minor changes in current diet to achieve recommended levels of carbohydrate over time.

The carbohydrate cheat sheet module provides, or display common eaten carbohydrate foods and price in accordance to the carbohydrate contents in the food. This tool utilizes average carbohydrate to improve user retention and compliance. The carbohydrate cheat sheet module provides, or display free vegetables, which does not count the carbohydrate in non-starchy vegetables. The carbohydrate cheat sheet module further comprises restricted amount of quantity for free vegetables, and recommends a way or type of intake. The vegetables may have low levels of carbohydrate, however, if the said vegetables are juiced, or intake in excessive amount would impact on the blood sugar level. The carbohydrate cheat sheet module could be separate guide tool, or digital tool incorporated in the computer system.

An interactive reinforcement of learning module provides interactive/communicative platform between the educator and the learners about the usage of digital currency. The interactive reinforcement of learning module is incorporated this platform via video, audio, or digital communication interface. For example, the correct answer receives a visual response, incorrect answer receives a different visual response, or text/audio explanation of the response. The interaction via this module, is incentivized as learners/users are collecting points for participation, and responded correct answers.

The measured comprehension of learning module conducts test or examination, and provides rewards for participation and score based on the user's answers/response in the test or exam. The measured comprehension of learning module provides a series of interactive questions or exercises to determine comprehension of the learners. This module is also incentivized for both participation and correct response by the users. Further, the module is configured to accumulate rewards in terms of points to exchange for discount cards, online vouchers, or lottery drawings. In an example, if the comprehension score is greater than 80%, respective user will receive incentives for repeating the course, and will be provided with an option of learning track, such as text, audio or visual, etc. And other kind of interventions will also be made available to increase comprehension or score, and engagement with this cornerstone of diabetic control.

In one embodiment, the learning and knowledge transfer module is configured to engage one or more users in exercises, activities, or motivate the users to record and implement the utilization of exchanging tool such as currency, etc. in accordance to the carbohydrate content of the food for a period. In some embodiments, the period could be three weeks before moving on to addition nutrient teachings. This module educates and knowledge transfer for the learners with ease on carbohydrate intake before educating the users on fat or protein.

The advantage of the teaching method via different modules incorporated in the computer system helps to manage carbohydrates in the user's diet. The teaching method educate the users to count all carbohydrate content in the food, and helps to maintain consistent carbohydrate intake that results in more consistent blood sugar, or glycated hemoglobin (HbA1c). By this knowledge, the user could master the recipes and suggest healthy food for diet. Prolonged usage of this system and method by the user, makes the user to follow it on routine living practice and provides motivation in the results.

The carbohydrate teaching method is appropriate for people from all background. The user could learn to eat a consistent amount of carbohydrate and space meals appropriately to stabilize after meal blood sugar response. The said learning is more important, because most of the people are not in diet due to their situations and circumstances. It also contributes to the loss of control, and people with chronic disease cite as a stressor inducing depression. Forbidding the nutrient content, or any type of food impacts the hypothalamus, where stress resulting in a storage of calories or poor metabolism. Further, the restrictive diets are proven to be ineffective long term.

In an example, the teaching method according to the present invention, does not forbid any food. It teaches a user that a food cost 45 cents to consume at a meal with protein and non-starchy vegetables and very little additional carbohydrate. The teaching method recognizes a healthy amount of carbohydrate intake, where the impact on after meal blood sugar is close to that of sandwich and orange. Henceforth, the user could psychologically at least know how to modify diet to accommodate the choice.

The teaching method further allows people or user to make the transition to label with ease. The method educates that, sugar is not alone carb source. This method encourages to use labels to personalize their carbohydrate cheat sheets. Add commonly eaten foods not on sheet in 15 cent portions by reading label and rounding to an average. Thus, this method is significant in improving retention. The teaching method empowers the users to handle special occasions, and reduce the stress associated with holidays, birthdays, and celebrations. For example, the user could learn and count calorie or carb level in the birthday cakes and Christmas dressing.

This teaching method is further quickly reinforced by blood sugar testing. With other known educational methods, the user often does not see blood sugars respond as expected with leads to non-compliance. After meal, the blood sugar level shows impact immediately by following this method. Users could be instructed to test before they taking/after applying this teaching method, where the user could observe the results instantly, where the blood sugars become stable, and carb intake has a direct impact of blood sugar.

This teaching method further reduces risk, and improves outcomes with medication adjustments. The medical or health provider could suggest effective medication adjustment to bring a user's blood sugars to goal with significantly less risk of severe hypoglycemia. The problems with current medication patterns are also easier to detect.

If the blood sugar is consistently low after meals, the health provider may suggest or determine less medication is needed. Consistently high blood sugars after meal, medication or additional medication may be needed to support the intake of the user. User may also be advised to reduce carb per meal of increase exercise. Consistent blood sugars pose less risk to patient/provider, while adjusting the medication, where the inconsistent blood sugars could result in life threatening blood sugar excursions.

The method further prepares patient for an appropriate response to a low blood sugar. The learners will have a good understanding of carbohydrates, and understand the impact on blood sugar, where the learners are more likely able to identify a 15-gm content of carbohydrate, which is the common recommended treatment for hypoglycemia, and respond appropriately.

The method further provides diet control to the individual, and empowers or motivate them to reach individual health goals. The system and method, according to the present invention further results in improved instant stabilization of blood sugars. This instant stabilization also contributes to a reduction in the mood swings, sweats, and irritability associated with unstable blood sugars.

The method is further reinforced immediately by blood sugar testing results. This method improves compliance with diet and with self-blood glucose monitoring. As a result, the users do have had success losing weight. User's concentration on improving blood sugars, which increase their hopes, lessen depression, increases energy levels, and user's willingness to further improve carbohydrate choices to pursue a higher level of wellness. Steady blood sugars within normal ranges, steady weight loss, empowers and encourages user's will power to make a way difference with diabetes.

The importance to stabilize blood sugars so they can be brought to goal (6% HbA1c) as quickly as possible with diet or diet and medication. A drop of 1% in HbA1c (If user has 8% Hba1c and drops to 7%) can result in a risk reduction of: retinopathy (eye damage) by 38%, nephropathy (kidney damage) by 28%, neuropathy (nerve damage) by 28% and cardiovascular (heart attack or stroke) event by 57%.

The risk of not having a good understanding of carbohydrate (grams) content in the food intake may lead to: Long term hyperglycemia as seen in people with diabetes appears to result in significant changes in their mood and cognitive state. For instance, Type 2 diabetes is bidirectional associated with depression. Chronic hyperglycemia increases the risk of cognitive decline in those with diabetes by 60-100%. This is primarily due to a higher risk of vascular dementia rather than that of Alzheimer's disease. The risk of Alzheimer's disease in people with diabetes, however, is elevated as well. Hypoglycemia is generally accepted to cause neuronal injury and impairments in mood and cognition. Moderate episodes of hypoglycemia have been shown to cause short term cognitive deficits, which increase the risk of motor vehicle accidents.

The unstable blood sugars after meals, or result of inconsistent carb intake can cause feelings of tiredness, a problem understanding simple tasks and increased tension. Frequent low blood sugars, which are common in diabetics receiving medication without understanding of carbohydrate, causes the brain metabolism to change after repeated episodes of hypoglycemia in a short amount of time. The patient's awareness of their own symptoms becomes impaired, due to these mechanisms. Lack of awareness on hypoglycemia in people with diabetes can be dangerous, because affected individuals do not realize that their blood glucose is low or high, where hypoglycemia may lead to unconsciousness and even death.

The results of carb teaching method in 200 Individuals with HbA1c>6.5, demonstrates 75% (150 individuals) completed Carb Cents teaching (Engagement), 42% (63 individuals) showed a corresponding decrease of >1% HbA1c in 90 days, and 73% (110 individuals) showed some improvement in HbA1c, and 30% (15 individuals) of the individuals, who did not complete the teaching method, but did returned for testing had an increase of >1% within 90 days.

The advantage of the present invention, is a tool developed based on carbohydrate content to its equivalent currency, or carbohydrate cents (carb cents) educating patients and families to count carbohydrates in their diet. This tool and method further utilizes the user familiarity on currency and cost of the items, where it develops a correlation to control the consumption of carbohydrate by recognizing the cost (grams) of carbohydrate in various food items.

The foregoing examples have been provided merely for the purpose of explanation and are in no way to be construed as limiting of the method, disclosed herein. While the method has been described with reference to various embodiments, it is understood that the words, which have been used herein, are words of description and illustration, rather than words of limitation. Further, although the method has been described herein with reference to particular means, materials, and embodiments, the method is not intended to be limited to the particulars disclosed herein; rather, the method extends to all functionally equivalent structures, methods and uses, such as are within the scope of the invention. Although there has been shown and described the preferred embodiment of the present invention, it will be readily apparent to those skilled in the art that modifications may be made thereto.

1. A dieting tool for educating controlled carbohydrate intake to a user, comprising:
a carbohydrate guide, wherein the carbohydrate guide comprises at least a list of consumable food items and a corresponding value of exchange article in accordance to the amount of carbohydrate in the consumable food items, thereby educating the user to count carbohydrate intake while purchasing/consuming the food items.

2. The dieting tool of claim 1, further comprising at least a list of consumable non-carbohydrate food items.

3. The dieting tool of claim 2, wherein the exchange article value for consumable non-carbohydrate food items is zero.

4. The dieting tool of claim 1, wherein the corresponding exchange article is currency.

5. A method for educating controlled carbohydrate intake to a user, comprising the steps of:
determining an optimal carbohydrate intake by a user;
providing a carbohydrate guide to the user, wherein the carbohydrate guide comprising at least a list of consumable food items and a corresponding value of exchange article in accordance to the amount of carbohydrate in the consumable food items, and
purchasing/consuming the food items using the exchange article value in accordance to the determined optimal carbohydrate intake by the user, thereby educating the user to count carbohydrate intake.

6. The method of claim 4, further comprising at least a list of consumable non-carbohydrate food items.

7. The method of claim 6, wherein the exchange article value for consumable non-carbohydrate food items is zero.

8. The method of claim 4, wherein the corresponding exchange article is currency.
